(19) United States
(12) Patent Application Publication
(10) Pub. No.: US 2006/0272199 A1
(43) Pub. Date: Dec. 7, 2006

(54) Aqueous gel candle for use with a warming device

(75) Inventors: Michael Licciardello, Spartanburg, SC (US); Kathleen Stewart LaPierre, Buffalo, SC (US)

Correspondence Address: DORITY & MANNING, P.A., POST OFFICE BOX 1449, GREENVILLE, SC, 29602-1449, US

(73) Assignee: BMC Manufacturing, LLC

(21) Appl. No.: 11/143,104

(22) Filed: Jun. 2, 2005

(51) Int. Cl. C11C 5/00

(52) U.S. Cl. 44/275

(57) ABSTRACT

A candle that is formed from an aqueous gel containing an aqueous phase and an oil phase is provided. During use, the aqueous gel is heated to cause the evaporation of one or more volatile fragrances contained within the gel matrix into the surrounding environment. In one particular embodiment, for example, the candle is heated with a warming device other than a wick.

BACKGROUND OF THE INVENTION

One technique commonly employed to provide a pleasant aroma to a surrounding environment involves the use of scented candles. Specifically, the wick of a scented candle may be lit to burn the candle wax and release a fragrance contained therein. Unfortunately, burning a scented candle creates an open flame that, if improperly attended to, may be hazardous in certain environments, such as in hotels, dorm rooms, nursing homes, hospitals, etc. In addition, the smoke generated by conventional scented candles may set off fire alarms or automatic sprinklers. Excessive use in the same location may also result in smoke stains on walls and ceilings adjacent to the candle. Scented candles may also burn unevenly around the wick to such an extent that the candle may no longer be used, even though a substantial portion of wax is still contained within the jar. Further, the flame from the wick may also cause the fragrance contained within conventional candles to breakdown or undergo substantial chemical modification.

In response to these and other difficulties, hot plates or coffee warmers have been employed in lieu of burning wicks to heat the scented candles. However, conventional wax candles do not readily release fragrances when heated in this manner. Thus, a need currently exists for a candle composition that is particularly suitable for use in conjunction with warming devices, and that is capable of releasing fragrances in a desired manner.

### SUMMARY OF THE INVENTION

In accordance with one embodiment of the present invention, an aroma-producing system is disclosed. The system comprises an aqueous gel having an aqueous phase and an oil phase. The gel contains a volatile fragrance. The system comprises a warming device that is capable of heating the gel so that the volatile fragrance is released from the gel into the surrounding environment.

In accordance with another embodiment of the present invention, a scented candle is disclosed that comprises a gel having an aqueous phase and an oil phase. The gel comprises a volatile fragrance and water in an amount of at least about 25 wt. %.

Other features and aspects of the present invention are discussed in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a perspective view of one embodiment of an aqueous gel candle of the present invention disposed within a container;

FIG. 2 is a perspective view of one embodiment of an aroma-producing system of the present invention that employs the candle of FIG. 1 and a warming device; and

FIG. 3 is a perspective view of another embodiment of an aroma-producing system of the present invention.

Repeat use of reference characters in the present specification and drawings is intended to represent same or analogous features or elements of the invention.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present invention, which broader aspects are embodied in the exemplary construction.

Generally speaking, the present invention is directed to a candle that is formed from an aqueous gel containing an aqueous phase and an oil phase. During use, the aqueous gel is heated to cause the evaporation of one or more volatile fragrances contained within the gel matrix into the surrounding environment. In one particular embodiment, for example, the candle is heated with a warming device other than a wick that burns the candle.

I. Aqueous Gel

The aqueous gel of the present invention is formed from an emulsion, i.e., a colloidal system formed from at least two immiscible liquid phases. At least one phase of the emulsion is an “aqueous” phase that contains water, and at least one phase is an “oil” or “fatty” phase that contains one or more ingredients that are substantially insoluble in water. For example, the emulsion may be an oil-in-water emulsion in which the oil phase is composed of droplets (also referred to as the discontinuous phase) that are finely dispersed in the water phase (also referred to as the continuous phase). At room temperature (e.g., about 25° C.), the emulsion of the present invention is also relatively non-flowable. That is, the emulsion has a sufficient viscosity such that it is considered a solid or semi-solid “gel” material. For instance, the aqueous gel of the present invention may have a viscosity of at least about 5,000 centipoise (cP), in some embodiments from about 10,000 to about 500,000 cP, and in some embodiments, from about 15,000 to about 400,000 cP, as measured using a Brookfield viscometer at 25° C.

The aqueous gel of the present invention may be formed from a variety of different substances, such as water, gelling agents, solubilizers, surfactants, volatile fragrances, and various other optional components. Substances that are predominantly hydrophilic in nature are typically added to the aqueous phase, while those that are predominantly lipophilic in nature are typically added to the oil phase. In this regard, various embodiments of the aqueous gel of the present invention will now be described in more detail. It should be understood, however, that the description below is merely exemplary, and that other embodiments are also contemplated in the present invention.

A. Water

Water serves multiple functions in the gel of the present invention. For example, in oil-in-water emulsions, water serves as the continuous phase of the emulsion into which the oil phase is dispersed. Further, water has a vapor pressure of about 0.3 mm Hg (at 25° C., 1 atm) and a boiling point of about 100° C. (at 1 atm), and as such, it is able to evaporate upon warming to help “carry” fragrances to the surrounding environment. In contrast, many liquid-base materials used in conventional gel candles (e.g., hydrocarbon oils) exhibit a vapor pressure of no more than about 0.2 mm Hg (at 25° C., 1 atm) and/or have a boiling point greater than about 230° C. (at 1 atm). Such “non-volatile” materials are thus not as effective as water in assisting the diffusion of a fragrance. Although the water content may vary based on the selected components of the aqueous gel, it is typically present in an amount greater than about 25 wt. %, in some embodiments greater than about 50 wt. %, and in some embodiments, from about 60 wt. % to about 95 wt. % of the aqueous gel.

B. Gelling Agents

The aqueous gel of the present invention generally contains a gelling agent that facilitates the formation of the gel. For example, the gelling agent may be capable of being dissolved or dispersed in water at an elevated temperature (e.g., above 50° C.) to form a dispersion or solution that will substantially thicken or harden to form a gel upon cooling to room temperature (about 25° C.). Any of a variety of gelling agents may be employed in the present invention. Suitable gelling agents may include, for instance, metal soaps, surfactants, homopolymers, copolymers, fumed silica, gums, waxes, clay, and so forth. For example, polymers that form a three dimensional gel network may be employed in some embodiments, such as a copolymer with at least two blocks, e.g., a diblock copolymer, a triblock copolymer, a radial block copolymer, a star polymer, a multi-block copolymer, and mixtures thereof. Such copolymers are described in more detail in U.S. Pat. Nos. 5,556,911 to Walther. et al. and U.S. Pat. No. 5,879,694 to Morrison, et al., as well as U.S. Patent Application Publication No. 2002/0022205 to Elliot, et. al., all of which are incorporated herein in their entirety by reference thereto for all purposes.

In certain embodiments of the present invention, derivatives (e.g., esters, ethers, or alcohols) of naturally-occurring fats, oils, waxes and/or rosins are employed as gelling agents in the aqueous gel. Such gelling agents are useful in that they are biodegradable and capable of substantially dissolving or dispersing in the aqueous phase of the emulsion. One particularly suitable class of gelling agents are derivatives of vegetable fats, such as metal salts of fatty acids (i.e., soaps). The fatty acids used to synthesize such gelling agents typically contain from about 14 to 22 carbon atoms. Specific examples of such fatty acids include myristic, palmitic, stearic, oleic, linoleic, linolenic, arachidic, behenic, margaric acids, and mixtures of such acids naturally occurring in fats, oils, waxes and/or rosins. Naturally occurring sources of such fatty acids include coconut oil, tallow, lanolin, fish oil, beeswax, palm oil, sesame oil, peanut oil, olive oil, palm kernel oil, cottonseed oil, soybean oil, corn oil, babassu oil, rapeseed oil, rosin acids, abietic acid, and greases. Conventional fractionation and/or hydrolysis techniques may be employed if desired to obtain the requisite types of fatty acids. The metal of such fatty acids salts may include sodium, potassium, lithium, calcium, aluminum, zinc, barium, and so forth. Particularly useful fatty acid soap gelling agents include sodium stearate, sodium palmitate, potassium stearate, potassium palmitate, and sodium myristate.

The concentration of the gelling agent is selected to exhibit minimal interfacial interaction. If the gelling agent concentration is too low, for instance, the resulting gel may become dimensionally unstable and interact with the contiguous phase of the emulsion. Likewise, if the gelling agent concentration is too large, the resulting gel may be too hard and lack the desired volatile-releasing characteristics. Thus, in most embodiments of the present invention, the gelling agent constitutes from about 1 wt. % to about 50 wt. %, in some embodiments from about 4 wt. % to about 25 wt. %, and in some embodiments, from about 4 wt. % to about 10 wt. % of the aqueous gel.

C. Solubilizers

In addition to a gelling agent, the aqueous gel also contains a solubilizer that helps dissolve or disperse the gelling agent. Examples of suitable solubilizers include, for instance, silicone oils; higher alcohols, such as cetyl alcohol, isostearyl alcohol, lauryl alcohol, hexadecyl alcohol, octyldodecanol, etc.; fatty acids, such as isostearic acid, undecylenic acid, oleic acid, etc.; polyhydric alcohols, such as glycerol, sorbitol, ethylene glycol, propylene glycol, dipropylene glycol, polyethylene glycol, etc.; esters, such as myristyl myristate, hexyl laurate, decyl oleate, isopropyl myristate, hexyldecyl dimethyloctanoate, glyceryl monostearate, diethyl phthalate, ethylene glycol monostearate, octyl oxystearate, etc.; hydrocarbons, such as n-tridecane, liquid paraffin, petrolatum, squalane, etc.; waxes, such as lanolin, reduced lanolin, carnauba wax, etc.; fats, such as mink oil, cacao oil, coconut oil, palm seed oil, camellia oil, sesame oil, castor oil, olive oil, etc.; ethylene/α-olefin co-ligomers; and so forth. In particular embodiments of the present invention, the solubilizer is a polyhydric aliphatic alcohol containing from 2 to 6 carbon atoms and from 2 to 3 hydroxyl groups. Some specific polyhydric alcohols that are suitable for use in the aqueous gel include ethylene glycol, propylene glycol, dipropylene glycol, trimethylene glycol, glycerine, 1,3-butane-diol and 1,4 butane-diol.

The concentration of the solubilizer may generally be any amount needed to help dissolve the gelling agent. For example, the solubilizer may constitute from about 0.1 wt. % to about 75 wt. %, in some embodiments from about 0.2 wt. % to about 25 wt. %, and in some embodiments, from about 0.5 wt. % to about 5 wt. % of the gel.

D. Surfactants

The aqueous gel of the present invention also contains one or more surfactants that are capable of performing a variety of functions, such as serving as emulsifiers, dispersants, thickeners, and so forth. For instance, because emulsions are inherently unstable and tend to separate into their constituent phases, emulsifying surfactants (or dispersants) are typically employed to help create and maintain the uniform fine dispersion of the inner phase in the outer phase, and retard or prevent coalescence of the droplets and eventual separation of the emulsion into its constituent phases. Likewise, surfactants may also be employed in the aqueous gel to help disperse or dissolve a volatile fragrance.

Although any surfactant may generally be employed in the present invention, the present inventors have discovered that nonionic surfactants having a certain hydrophilic/lipophilic balance (“HLB”) may improve the long-term stability of the aqueous gel. The HLB index is well known in the art and is a scale that measures the balance between the hydrophilic and lipophilic solution tendencies of a compound. The HLB scale ranges from 1 to approximately 50, with the lower numbers representing highly lipophilic tendencies and the higher numbers representing highly hydrophilic tendencies. In some embodiments of the present invention, the HLB value of the surfactants is from about 8 to about 30, in some embodiments from about 10 to about 25 and in some embodiments, from about 12 to about 18. If desired, two or more surfactants may be employed that have HLB values either below or above the desired value, but together have an average HLB value within the desired range.

Nonionic surfactants typically have a hydrophobic base, such as a long chain alkyl group or an alkylated aryl group, and a hydrophilic chain comprising a certain number (e.g., 1 to about 30) of ethoxy and/or propoxy moieties. The particular type of nonionic surfactant employed generally depends on its intended function, the desired properties of the aqueous gel, and so forth. For instance, some suitable classes of nonionic surfactants that may be used include, but are not limited to, ethoxylated alkylphenols, ethoxylated and propoxylated fatty alcohols, polyethylene glycol ethers of methyl glucose, polyethylene glycol ethers of sorbitol, ethylene oxide-propylene oxide block copolymers, ethoxylated esters of fatty (C₈-C₁₈) acids, condensation products of ethylene oxide with long chain amines or amides, condensation products of ethylene oxide with alcohols, and mixtures thereof.

One particular class of suitable nonionic surfactants includes nonionic esters or ethers having a polyoxyalkylene moiety (e.g., polyoxyethylene) and/or containing a polyhydroxy compound, such as glycerol, sorbitol, or other hydrophilic moiety. Such surfactants may also contain a hydrophobic alkyl, alkenyl or aralkyl moiety, normally containing from about 8 to 250 carbons and particularly from 10 to 200 carbons. The hydrophobic moiety may be either linear or branched, and saturated or unsaturated. If desired, the hydrophobic moiety may include a mixture of chain lengths, such as those derived from tallow, lard, palm oil, sunflower seed oil or soya bean oil. Particularly desired surfactants include polyethylene glycol monoesters and diesters having the following general formulae:
R—C(O)O—(O—CH₂—CH₂—)ₙ—OH (monoester)
R—C(O)O—(O—CH₂—CH₂—)ₙ—CO(O)—R′ (diester)
wherein R and R′ are independently a branched or unbranched, alkyl or alkenyl radical; and

n is 4 or more, in some embodiments 8 or more, in some embodiments 20 or more, and in some embodiments, 100 or more. Specific examples of such polyethylene glycol ethers include, for instance, PEG-150 distearate (HLB of 18.4), PEG-150 monostearate (HLB of 17.6), PEG-100 monostearate (HLB of 18.8), PEG-8 dioleate (HLB of 7.2), PEG-8 distearate (HLB of 8.2), PEG-8 monooleate (HLB of 8.4), PEG-8 dilaurate (HLB of 10.0), PEG-12 monotallate (HLB of 10.0), PEG-8 monostearate (HLB of 11.1), PEG-8 monolaurate (HLB of 12.8), PEG-20 monostearate (HLB of 15.6), and PEG-40 monostearate (HLB of 17.2).

Other suitable nonionic surfactants may include ethoxylates, including fatty acid ester ethoxylates, fatty acid ether ethoxylates, and ethoxylated sugar derivatives (e.g., ethoxylated fatty acid polyesters, ethoxylated fatty acid sorbitan esters, and the like), etc. Representative ethoxylated fatty acid sorbitan esters include, for instance, polyoxyethylene sorbitan laurate (i.e., Polysorbate-20 (HLB of 16.7) and Polysorbate-21 (HLB of 13.3)), polyoxyethylene sorbitan palmitate (i.e., Polysorbate-40 (HLB of 15.6)), polyoxyethylene sorbitan stearate (i.e., Polysorbate-60 (HLB of 14.9) and Polysorbate-61 (HLB of 9.6)), polyoxyethylene sorbitan tristearate (i.e., Polysorbate-65 (HLB of 10.5)), polyoxyethylene sorbitan oleate (i.e., Polysorbate-80 (HLB of 15.0) and 81 (HLB of 10.0)), polyoxyethylene sorbitan trioleate (i.e., Polysorbate-85 (HLB of 11.0)), and so forth. Among the aforementioned ethoxylated fatty acid sorbitan esters, polysorbate-20 is generally preferred.

The amount of surfactants employed may depend on the particular class of surfactant and the respective levels of the oil and the aqueous phases in the aqueous gel. For example, the total amount of surfactants may range from about 0.1 wt. % to about 25 wt. %, in some embodiments from about 0.5 wt. % to about 15 wt. %, and in some embodiments, from about 1 wt. % to about 5 wt. % of the aqueous gel. In one particular embodiment, the aqueous gel utilizes a combination of an emulsifying surfactant (e.g., PEG-150 distearate) and a solubilizing surfactant (e.g., Polysorbate-20) for the fragrance. In such embodiments, the emulsifying surfactant may constitute from about 0.01 wt. % to about 10 wt. %, in some embodiments from about 0.1 wt. % to about 6 wt. %, and in some embodiments, from about 0.2 to about 2 wt. % of the aqueous gel. Likewise, the solubilizing surfactant may constitute from about 0.05 wt. % to about 20 wt. %, in some embodiments from about 0.5 wt. % to about 12 wt. %, and in some embodiments, from about 1 to about 5 wt. % of the aqueous gel.

E. Volatile Fragrances

The aqueous gel of the present invention is capable of releasing one or more volatile fragrances upon heating. As used herein, the term “volatile” or vaporizable substance refers to any material released from the aqueous gel to the surrounding atmosphere upon exposure to a certain amount of heat. The volatile fragrance typically has a vapor pressure that is greater than the vapor pressure of the gel at the “diffusion temperature” , which is the temperature under conditions of use at which the vaporizable substance diffuses into the surrounding atmosphere upon exposure to heat. For example, the volatile fragrance may begin to diffuse into the surrounding environment at temperatures of greater than about 60° C., in some embodiments greater than about 70° C., and in some embodiments, greater than about 80° C.

Any fragrance conventionally employed in scented candles, air fresheners, potpourri, perfumes, etc., may be employed in the present invention. For instance, some suitable fragrances may include myrrh, cedarwood, cedrenol, cedrol, birch, methyl salicylate, fir balsam, sandalwood, santalol, juniper, benzoin, coniferyl benzoate, thyme, thymol, bay, eugenol, myrcene, basil, camphor, methyl cinnamate, cinnamon, cinnamic aldehyde, rosemary, clove, and bomeol. Still other suitable fragrances include limonene, α-terpinene, α-pinene, camphene, undecanol, 4-isopropylcyclohexanol, geraniol, linalool, citronellol, farnesol, menthol, 3-trans-isocamphylcyclohexanol, benzyl alcohol, 2-phenylethyl alcohol, 3-phenylpropanol, 3-methyl-5-phenylpentanol, cinnamic alcohol, isobomeol, thymol, eugenol, isoeugenol, anise alcohol, methyl salicylate, etc. Other suitable fragrances include aldehydes and ketones, such as hexanal, decanal, 2-methyldecanal, trans-2-hexenal, acetoin, diacetyl, geranial, citronellal, methoxydihydro-citronellal, menthone, carvone, camphor, fenchone, ionone, irone, damascone, cedryl methyl ketone, muscone, civetone, 2,4-dimethyl-3-cyclohexene carboxaldehyde, 2-heptylcyclopentanone, cis-jasmone, dihydrojasmone, cyclopentadecanone, benzaldehyde, phenylacetaldehyde, dihydrocinnamaldehyde, cinnamaldehyde, α-amylcinnamaldehyde, acetophenone, benzylacetone, benzophenone, piperonal, etc. Still other suitable fragrance compounds include esters, such as trans-2-hexenyl acetate, allyl 3-cyclohexylpropionate, methyl cinnamate, benzyl cinnamate, phenylethyl cinnamate, etc.

The fragrance may be in liquid or solid form, such as a freeze-dried or encapsulated powder. Most conventional fragrance materials are volatile essential oils. Such oils may be synthetically or naturally derived. Naturally derived fragrant oils may include, for instance, bergamot, caraway, geranium, lavender, origanum, petitgrain, white cedar, patchouli, lavandin, neroli, rose absolute, and so forth. Synthetic fragrances may likewise include geraniol, geranyl acetate, isoeugenol, linalool, linalyl acetate, phenethyl alcohol, methyl ethyl ketone, methylionone, isobomyl acetate, etc. Still other synthetic fragrance compositions may be employed, either alone or in combination with natural oils, such as described in U.S. Pat. Nos. 4,324,915; 4,411,829; and 4,434,306, which are incorporated herein in their entirety by reference thereto for all purposes. In contrast to fragrant oils, crystalline or solid fragrances may sublime into the vapor phase at ambient temperatures. Exemplary crystalline fragrances include vanillin, ethyl vanillin, coumarin, tonalid, calone, heliotropene, musk xylol, cedrol, musk ketone benzophenone, raspberry ketone, methyl naphthyl ketone beta, phenyl ethyl salicylate, veltol, maltol, maple lactone, proeugenol acetate, evemyl, etc.

The amount of the volatile fragrance used in the aqueous gel generally depends on the nature of the fragrance and the degree to which it is desired that the gel release the fragrance. One particular benefit of the present invention, however, is that the gel is able to release a greater level of the volatile fragrance within a given time period than conventional candles. Thus, a lower level of the volatile fragrance may sometimes be employed to achieve the desired effect. For example, the amount of the active substance may range from about 0.1 wt. % to about 20 wt. %, in some embodiments from about 0.5 wt. % to about 15 wt. %, and in some embodiments, from about 1 wt. % to about 10 wt. % of the aqueous gel.

Besides fragrances, other volatile substances may also be released from the aqueous gel candles of the present invention. Representative examples of such volatile substances that may be released from a heated gel include insect repellants, medicaments, disinfectants, deodorants, cleansing agents, etc. Suitable insect repellents include, for instance, citronella, DEET, terpineol, and benzalacetone. As is well known in the art, the amount of such volatile substances may generally vary depending on the nature of the substance and the desired effect.

F. Preservatives

The aqueous gel may optionally contain a preservative or preservative system to inhibit the growth of microorganisms. Stable preservatives for use in the present compositions include, for instance, alkanols, disodium EDTA (ethylenediamine tetraacetate), EDTA salts, EDTA fatty acid conjugates, isothiazolinone, parabens (e.g., methylparaben and propylparaben), propylene glycols, sorbates, urea derivatives (e.g., diazolindinyl urea), etc. Preferably, the preservative system includes propylene glycol, diazolidinyl urea, methylparaben, propylparaben, or combinations thereof. In one particular embodiment, the preservative system is a combination of 56% propylene glycol, 30% diazolidinyl urea, 11% methylparaben, and 3% propylparaben. Such a combination is available under the name GERMABEN® II from International Specialty Products of Wayne, N.J. When utilized, the preservative or preservative system may be present in an amount of from about 0.01 wt. % to about 5 wt. %, in some embodiments from about 0.1 wt. % to about 2 wt. %, and in some embodiments, from about 0.5 wt. % to about 1.5 wt. % of the aqueous gel.

G. Chelating Agents

Chelating agents may be employed in some embodiments of the present invention to enhance the effect of the preservative system. Some examples of chelating agents that may be used in the aqueous gel of the present invention include, but are not limited to, ethylenediamines, ethylenediaminetetraacetic acids (EDTA) acid and/or salts thereof, citric acids and/or salts thereof, glucuronic acids and/or salts thereof, polyphosphates, organophosphates, dimercaprols, and so forth. When utilized, the chelating agent may be present in an amount of from about 0.001 wt. % to about 5 wt. %, in some embodiments from about 0.01 wt. % to about 1 wt. %, and in some embodiments from about 0.05 to about 0.5 wt. % of the aqueous gel.

H. UV Stabilizers

If desired, the aqueous gel of the present invention may also include an ultraviolet (UV) stabilizer or absorber to reduce the amount of fragrance prematurely released from the gel. Any suitable UV absorber may be used in the aqueous gel of the present invention. Some examples of suitable UV absorbers include, for instance, benzotriazoles (e.g., 2-(2′-hydroxyphenyl)benzotriazoles), benzophenones (e.g., 2-hydroxybenzophenones), benzoxazinones, triazines (e.g., 2-(2-hydroxyphenyl)-1,3,5-triazines), phenyl salicylates, cinnamates, oxanilides, and so forth. Specific examples of suitable 2-(2′-hydroxyphenyl)benzotriazoles include 2-(2′-hydroxy-5′-methylphenyl)-benzotriazole; 2-(3′,5′-di-tert-butyl-2′-hydroxyphenyl)benzotriazole; 2-(5′-tert-butyl-2′-hydroxyphenyl)benzotriazole; 2-(2′-hydroxy-5′-(1,1,3,3-tetramethylbutyl)phenyl)benzotriazole; 2-(3′,5′-di-tert-butyl-2′-hydroxy-phenyl)-5-cholorobenzotriazole; 2-(3′-tert-butyl-2′-hydroxy-5′-methylphenyl)-5-chloro-benzotriazole; 2-(3′-sec-butyl-5′-tert-butyl-2′-hydroxyphenyl)benzotriazole; 2-(2′-hydroxy-4′-octoxyphenyl)benzotriazole; 2-(3′, 5′-di-tert-amyl-2′-hydroxyphenyl)benzotriazole; 2-(3′,5′-bis(α,α-dimethylbenzyl)-2′-hydroxyphenyl)-benzotriazole; a mixture of 2-(3′-tert-butyl-2′-hydroxy-5′-(2-octyloxycarbonylethyl)-phenyl)-5-chloro-benzotriazole; 2-(3′-tert-butyl-5′-[2-(2-ethylhexyloxy)-carbonylethyl]-2′-hydroxyphenyl)-5-chloro-benzotriazole; 2-(3′-tert-butyl-2′-hydroxy-5′-(2-methoxycarbonylethyl)phenyl)5-chloro-benzotriazole; 2-(3′-tert-butyl-2′-hydroxy-5′-(2-methoxycarbonylethyl)phenyl)benzotriazole; 2-(3′-tert-butyl-2′-hydroxy-5′-(2-octyloxycarbonylethyl)phenyl)benzotriazole; 2-(3′-tert-butyl-5′-[2-(2-ethylhexyloxy)carbonylethyl]-2′-hydroxyphenyl)benzotriazole; 2-(3′-docecyl-2′-hydroxy-5′-methylphenyl-)benzotriazole and 2-(3′-tert-butyl-2′-hydroxy-5′-(2-isooctyloxycarbonylethyl)phenylbenzotriazole; 2,2-methylenebis[4-(1,1,3,3-tetramethylbutyl)-6-benzotriazol-2-ylphenol]; the transesterification product of 2-[3′-tert-butyl-5′-(2-methoxycarbonylethyl)-2′-hydroxyphenyl]benzotriazole with polyethylene glycol 300; and [R—CH₂CH—COO(CH₂)₃]₂ B, where R is 3′-tert-butyl-4′-hydroxy-5′-2H-benzotriazol-2-ylphenyl, and derivatives thereof.

In addition, specific examples of suitable 2-hydroxybenzophenones include 2-hydroxy-4-hydroxy-benzophenone; 2-hydroxy-4-methoxy-benzophenone; 2-hydroxy-4-octoxy-benzophenone; 2-hydroxy-4-decyloxy-benzophenone; 2-hydroxy-4-dodecylox-benzophenone; 2-hydroxy-4-benzyloxy-benzophenone; 2′,4,4′-trihydroxy-benzophenones; 2-hydroxy-4,4′-dimethoxy-benzophenone; 2,2′-dihydroxy-4-methoxybenzophenone; 2-hydroxy-4-n-octoxy-benzophenone, and derivatives thereof. Likewise, specific examples of suitable hindered hydroxybenzoate compounds include 2,4-di-tert-butylphenyl-3,5-di-tert-butyl-4-hydroxybenzoate; hexadecyl-3,5-di-tert-butyl-4-hydroxybenzoate; octadecyl-3,5-di-tert-butyl-4-hydroxybenzoate; octyl-3,5-di-tert-butyl-4-hydroxybenzoate; tetradecyl-3,5-di-tert-butyl-4-hydroxybenzoate; behenylyl-3,5-di-tert-butyl-4-hydroxybenzoate; 2-methyl-4,6-di-tert-butylphenyl-3,5-di-tert-butyl-4-hydroxybenzoate; and butyl-3-[3-t-butyl-4-(3,5-di-t-butyl-4-hydroxybenzoyloxy)phenyl]propionate. One particular example of a suitable UV absorber is a derivative of 2-hydroxy-4-hydroxy-benzophenone-5-sulfonic acid (i.e., a benzophenone derivative also known as “Benzophenone-4”), which is commercially available from BASF Corp. under the name Uvinul® MS-40.

When utilized, the UV absorber may be present in an amount of from about 0.001 wt. % to about 5 wt. %, in some embodiments from about 0.01 wt. % to about 1 wt. %, and in some embodiments from about 0.02 to about 0.1 wt. % of the aqueous gel.

I. Colorants

If desired, the aqueous gel may also include a colorant (e.g., pigment or dye). One class of suitable pigments, for instance, are organic pigments, such as azo, azomethine, methine, anthraquinone, phthalocyanine, perinone, perylene, diketopyrrolopyrrole, thioindigo, iminoisoindoline, dioxazine, iminoisoindolinone, quinacridone, flavanthrone, indanthrone, anthrapyrimidine and quinophthalone pigments. Specific pigments that may be used are those described in the Color Index, including but not limited to C.I. Pigment Red 202, C.I. Pigment Red 122, C.I. Pigment Red 179, C.I. Pigment Red 170, C.I. Pigment Red 144, C.I. Pigment Red 177, C.I. Pigment Red 254, C.I. Pigment Red 255, C.I. Pigment Red 264, C.I. Pigment Brown 23, C.I. Pigment Yellow 95, C.I. Pigment Yellow 109, C.I. Pigment Yellow 110, C.I. Pigment Yellow 147, C.I. Pigment Yellow 191.1, C.I. Pigment Yellow 74, C.I. Pigment Yellow 83, C.I. Pigment Yellow 13, C.I. Pigment Orange 61, C.I. Pigment Orange 71, C.I. Pigment Orange 73, C.I. Pigment Orange 48, C.I. Pigment Orange 49, C.I. Pigment Blue 15, C.I. Pigment Blue 60, C.I. Pigment Violet 23, C.I. Pigment Violet 29, C.I. Pigment Violet 37, C.I. Pigment Violet 19, C.I. Pigment Green 7, and C.I. Pigment Green 36. Inorganic pigments may also be employed, such as carbon black, iron oxide, antimony yellow, lead chromate, lead chromate sulfate, lead molybdate, ultramarine blue, cobalt blue, manganese blue, chrome oxide green, hydrated chrome oxide green, cobalt green, metal sulfides, cadmium sulfoselenides, zinc ferrite, and bismuth vanadate, titanium dioxide.

Generally, the colorant may be employed in any amount sufficient to impart the desired color. For instance, the colorant may constitute from about 0.001 wt. % to about 10 wt. %, in some embodiments from about 0.01 wt. % to about 5 wt. %, and in some embodiments, from about 0.1 wt. % to about 1 wt. % of the aqueous gel.

J. pH Adjusters

The pH of the treatment composition may be controlled within a certain range so that the volatile fragrance does not undergo substantial chemical modification upon heating to the diffusion temperature, and so that a desired viscosity is achieved for the gel. In this regard, it is typically desired that the pH be maintained at a relatively neutral level, such as from about 5 to about 9, in some embodiments from about 6 to about 8, and in one embodiment, about 7. Although not required, various pH modifiers may be utilized in the aqueous gel to achieve the desired pH level. For instance, some examples of basic pH modifiers that may be used in the present invention include, but are not limited to, ammonia; mono-, di-, and tri-alkyl amines; mono-, di-, and tri-alkanolamines; alkali metal and alkaline earth metal hydroxides; alkali metal and alkaline earth metal silicates; and mixtures thereof. Specific examples of basic pH modifiers are ammonia; sodium, potassium, and lithium hydroxide; sodium, potassium, and lithium meta silicates; monoethanolamine; triethylamine; isopropanolamine; diethanolamine; and triethanolamine. Moreover, some examples of acidic pH modifiers that may be used in the present invention include, but are not limited to, mineral acids, sulfonic acids (e.g., 2-[N-morpholino]ethane sulfonic acid), carboxylic acids, and polymeric acids. Specific examples of suitable mineral acids are hydrochloric acid, nitric acid, phosphoric acid, and sulfuric acid. Specific examples of suitable carboxylic acids are citric acid, glycolic acid, lactic acid, maleic acid, malic acid, succinic acid, glutaric acid, benzoic acid, malonic acid, salicylic acid, gluconic acid, and mixtures thereof. Specific examples of suitable polymeric acids include straight-chain poly(acrylic) acid and its copolymers (e.g., maleic-acrylic, sulfonic-acrylic, and styrene-acrylic copolymers), cross-linked polyacrylic acids having a molecular weight of less than about 250,000, poly(methacrylic)acid, and naturally occurring polymeric acids such as carageenic acid, carboxymethyl cellulose, and alginic acid. When utilized, the pH adjuster may be present in any effective amount needed to achieve the desired pH level.

II. Scented Candles

The aqueous gel of the present invention may be used to form any type of scented candle known in the art, including, for instance, jar candles, votives, tealights, tarts, pillars, wax potpourri, etc. The aqueous gel candle may also have any desired shape and/or size, and may also be self-supporting (or free-standing) or disposed within a container (e.g., jar). Self-supporting candles, for instance, may be made by pouring an emulsion into a mold, allowing the emulsion to gel, and then releasing the resulting candle from the mold. Likewise, candles may be formed by pouring an emulsion into a container, and then allowing it to cool to form the aqueous gel.

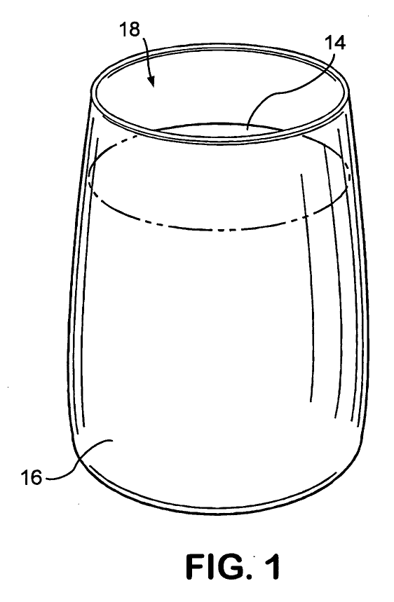

Referring to FIG. 1, for instance, one particular embodiment of an aqueous gel candle 14 is shown that is disposed within a container 16 that provides support and/or inhibits spillage of the gel. In this embodiment, the candle 14 has a circular base and tapered sidewalls, with the container 16 having a shape and size corresponding to the shape and size of the candle 14. The container 16 may be made from any of a variety of materials, but is typically thermally conductive so that heat is readily transferred to the candle 14 during use. Typical materials include glass, ceramics, earthenware, metals, or other heat conductive materials. The container 16 may be clear, opaque, translucent, or otherwise decorated. In addition, the container 16 also defines an opening 18 through which the fragrance may be released. Although not shown, a top or lid may optionally be employed to cover the opening 18 prior to the desired release of the fragrance. The lid may prevent the release of the fragrance, or it may contain one or more openings to allow the fragrance to dissipate therethrough. If desired, such a perforated lid may be employed during use to control the extent of the fragrance released to the surrounding environment. In addition, the candle 14 may also be provided with one or more air channels through which the evaporating fragrance is capable of flowing to enhance its release to the surrounding environment.

In accordance with the present invention, the fragrance of the aqueous gel candle is released upon heating to a certain temperature (e.g., its melting temperature). As used herein, the term “candle” includes embodiments in which a wick is used to burn the aqueous gel and also embodiments in which the gel is wickless. Preferably, the gel is wickless and instead heated using a warming device, such as those that are electrically operated, to provide the production of the desired aroma without the combustion dangers inherent in burning conventional candles. This may be particularly useful in areas where open flames are not allowed, such as office buildings, dormitories, nursing homes, and apartment complexes. Also, because the warming device does not burn the fragrance, the life of the candle may also be extended.

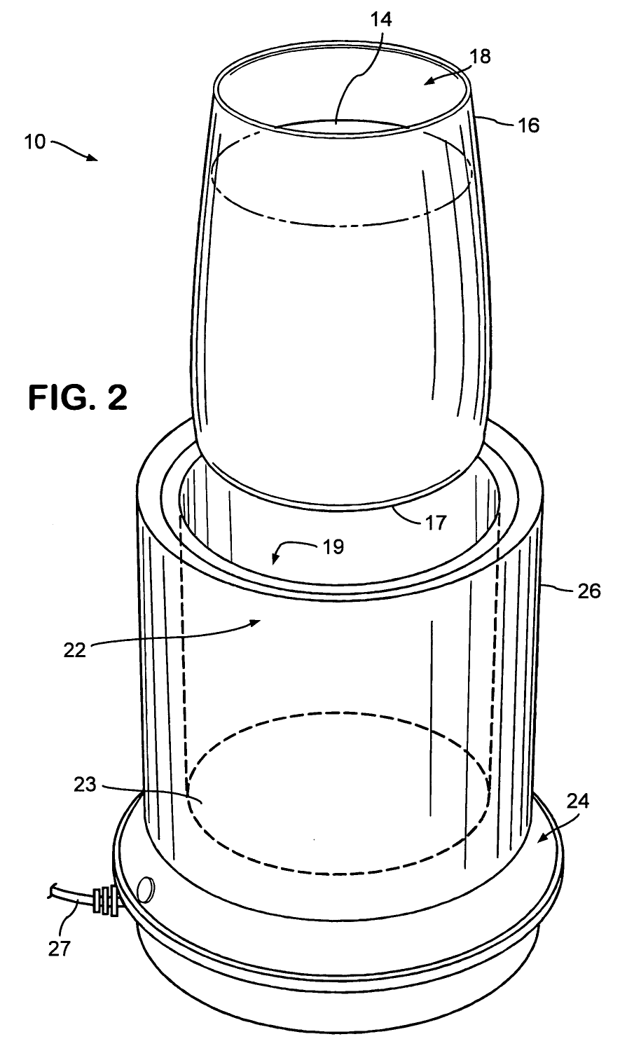

Any warming device capable of providing the desired level of heat may generally be utilized in the present invention. Referring to FIG. 2, for instance, one embodiment of an aroma-producing system 10 is shown that includes a warming device 22 and the candle 14 of FIG. 1. In this embodiment, the warming device 22 has a generally circular base 24 and a sidewall 26 that circumscribes the base 24 and extends upwardly therefrom. The upper portion of the sidewall 26 defines a receptacle 19 through which the container 16 is capable of being inserted such that a bottom surface 17 of the container 16 is able to rest on an upper surface 23 of the base 24. When positioned on the base 24, the sidewall 26 helps support the container 17 and inhibits spillage of the gel. Alternatively, the candle 14 may not be disposed within a container, but instead simply contained by the sidewall 26 during use. The sidewall 26 may also be formed from an insulative material to optimize heating efficiency.

The warming device 22 also includes an electric heating element (not shown) that is capable of heating the candle 14. Although not required, the electric heating element is typically disposed within the interior of the base 24 so that it is not exposed to outer environment, and is likewise positioned to heat the surface 23. The electric heating element may be of any type known to those skilled in the art that provides for the desired heat transfer. In one embodiment, for instance, the heating element is a Positive Temperature Coefficient (PTC) heating element. PTC heating elements generally have an extreme positive temperature coefficient over a very narrow range of temperatures. As such, PTC heating elements may be self-regulated at a preset temperature and automatically vary wattage to maintain a preset temperature. The electric heating element may also be in communication with a power supply, such as an AC or DC power source (e.g., an AC wall outlet), via an electric cord 27. Of course, embodiments are also contemplated in which the warming device is plugged directly into a wall outlet without the use of an electric cord. It should also be understood that the heating element is not restricted to electrical heating elements, but may also include solar heating elements, chemical-heating elements that produce heat in response to a chemical reaction (e.g., combustible candles), and so forth.

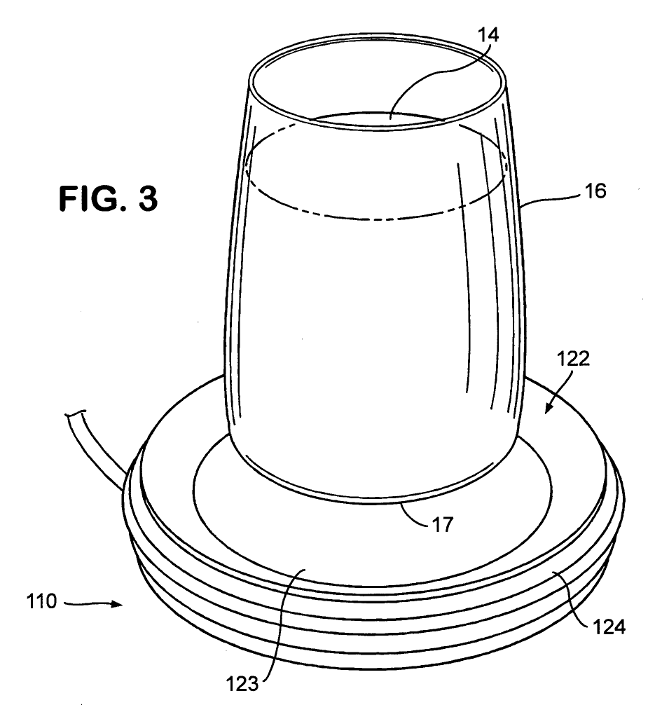

Other warming device configurations may also be employed in the present invention. Referring to FIG. 3, for instance, an aroma-producing system 110 is shown that uses an alternative warming device 122 in conjunction with the candle 14 of FIG. 1. The warming device 122 includes a generally circular base 124 that defines an upper surface 123 on which a bottom surface 117 of the container 116 is capable of resting. The warming device 122 also includes an electric heating element (not shown), which is typically disposed within the interior of the base 124. Unlike the device 22 of FIG. 2, however, the warming device 122 of FIG. 3 does not include a sidewall. Of course, it should be understood that any of a variety of other warming devices may be utilized in the present invention. For example, the warming device may contain a portion that also supplies heat to the top of the candle 14. Still other suitable warming devices are described in U.S. Pat. No. 5,891,400 to Ansari. et al., and U.S. Patent Application Nos. 2003/0007887 to Roumpos, et al. and 2003/0209533 to Tanner, et al., all of which are incorporated herein in their entirety by reference thereto for all purposes.

The present invention may be better understood with reference to the following examples.

### EXAMPLE 1

The ability to release heat an aqueous gel candle with a warming device was demonstrated. A variety of fragrances were used to form the gels, including “spice” , “floral” , “fresh”, “ozone” , “baked”, “green”, “citrus” , “musk”, “woods” , and “balsam” fragrances, all of which are available from Bridgewater Candle Co. of Buffalo, S.C. For such fragrances, aqueous gels were formed having the following composition:

| Component | Wt. % |
|---|---|
| Water | 84.85 |
| EDTA | 0.10 |
| Sodium Stearate | 6.00 |
| Dipropylene Glycol | 2.00 |
| Polysorbate-20 | 2.00 |
| PEG-150 distearate | 1.00 |
| Benzophenone -4 | 0.05 |
| Germaben ® II | 1.00 |
| Fragrance | 3.00 |
| Dyes | q.s. |

The continuous, aqueous phase was constituted by water, EDTA, sodium stearate, PEG-150 distearate, benzophenone-4, and the dyes. The discontinuous, oil phase was constituted by dipropylene glycol, Polysorbate-20, Germaben® II, and the fragrance. More specifically, water was initially loaded into a batch tank and heated to a temperature of 160° F. (˜71° C.) to 170° F. (˜77° C.) under agitation. EDTA and the dyes were then added into the batch tank until dissolved. Thereafter, sodium stearate and benzophenone-4 were added until dissolved. The remaining components were premixed and then added into the batch tank and the mixture was agitated for 5 to 15 minutes. The contents of the batch tank were discarded into a container and cooled for approximately 1 to 2 hours until a solid gel was formed.

The evaporation rates of the resulting gels were then tested. Specifically, gel/containers were initially weighed and placed on a warming device. The samples had a weight of between about 900 to 950 grams. After turning on the warming device, it was determined that the gels liquefied at a temperature of about 129° F. (˜54° C.). This temperature was then slowly increased to a final temperature of between 180° F. (˜82° C.) to 190° F. (˜88° C.) to evaporate the fragrance. Every 4 hours, the gel/container samples were re-weighed, and the evaporation rate was determined by subtracting the measured weight from the original weight and then dividing this calculated weight by the time interval. This process was continued until the entire gel was evaporated. The average evaporation rate for the gels was between about 8 to 10 grams per hour. Based on the percentage of the fragrance contained within the gel, it was thus determined that the average evaporation rate of the fragrance was between about 0.24 to about 0.30 grams per hour.

### EXAMPLE 2

Aqueous gels were formed as described in Example 1, except that the concentration of PEG-150 distearate was decreased from 1.0 wt. % to 0.50 wt. %. The resulting gels had the following composition:

| Component | Wt. % |
|---|---|
| Water | 85.35 |
| EDTA | 0.10 |
| Sodium Stearate | 6.00 |
| Dipropylene Glycol | 2.00 |
| Polysorbate-20 | 2.00 |
| PEG-150 distearate | 0.50 |
| Benzophenone -4 | 0.05 |
| Germaben ® II | 1.00 |
| Fragrance | 3.00 |
| Dyes | q.s. |

After testing the samples as described in Example 1, it was determined that the average evaporation rate of the fragrance was between about 0.24 to about 0.30 grams per hour.

### EXAMPLE 3

Aqueous gels were formed as described in Example 1, except that the concentration of sodium stearate was decreased from 6.0 wt. % to 4.0 wt. % and the concentration of PEG-150 distearate was increased from 1.0 wt. % to 2.0 wt. %. The resulting gels had the following composition:

| Component | Wt. % |
|---|---|
| Water | 85.85 |
| EDTA | 0.10 |
| Sodium Stearate | 4.00 |
| Dipropylene Glycol | 2.00 |
| Polysorbate-20 | 2.00 |
| PEG-150 distearate | 2.00 |
| Benzophenone -4 | 0.05 |
| Germaben ® II | 1.00 |
| Fragrance | 3.00 |
| Dyes | q.s. |

After testing the samples as described in Example 1, it was determined that the average evaporation rate of the fragrance was about 0.27 to about 0.33 grams per hour.

### EXAMPLE 4

Aqueous gels were formed as described in Example 1, except that the concentration of dipropylene glycol was increased from 2.0 wt. % to 20.0 wt. %, and PEG-150 distearate and Germaben® II were removed. The resulting gels had the following composition:

| Component | Wt. % |
|---|---|
| Water | 68.85 |
| EDTA | 0.10 |
| Sodium Stearate | 6.00 |
| Dipropylene Glycol | 20.00 |
| Polysorbate-20 | 2.00 |
| Benzophenone -4 | 0.05 |
| Fragrance | 3.00 |
| Dyes | q.s. |

After testing the samples as described in Example 1, it was determined that the average evaporation rate of the fragrance was about 0.21 to about 0.27 grams per hour.

### EXAMPLE 5

Aqueous gels were formed as described in Example 1, except that the concentration of dipropylene glycol was increased from 2.0 wt. % to 15.0 wt. %, and PEG-150 distearate, benzophenone4, and Germaben® II were removed. The resulting gels had the following composition:

| Component | Wt. % |
|---|---|
| Water | 73.90 |
| EDTA | 0.10 |
| Sodium Stearate | 6.00 |
| Dipropylene Glycol | 15.00 |
| Polysorbate-20 | 2.00 |
| Fragrance | 3.00 |
| Dyes | q.s. |

After testing the samples as described in Example 1, it was determined that the average evaporation rate of the fragrance was about 0.24 to about 0.30 grams per hour.

### EXAMPLE 6

Aqueous gels were formed as described in Example 1, except that the 10 concentration of dipropylene glycol was increased from 2.0 wt. % to 10.0 wt. %, and PEG-150 distearate, benzophenone-4, and Germaben® II were removed. The resulting gels had the following composition:

| Component | Wt. % |
|---|---|
| Water | 78.90 |
| EDTA | 0.10 |
| Sodium Stearate | 6.00 |
| Dipropylene Glycol | 10.00 |
| Polysorbate-20 | 2.00 |
| Fragrance | 3.00 |
| Dyes | q.s. |

After testing the samples as described in Example 1, it was determined that the average evaporation rate of the fragrance was about 0.27 to about 0.33 grams per hour.

### EXAMPLE 7

Aqueous gels were formed as described in Example 1, except that the concentration of sodium distearate was increased from 6.0 wt. % to 10.0 wt. %; the concentration of Polysorbate-20 was increased from 2.0 wt. % to 4.0 wt. %; the concentration of the fragrance was reduced from 3.0 wt. % to 2.0 wt. %; and PEG-150 distearate, benzophenone-4, and Germaben® II were removed. The resulting gels had the following composition:

| Component | Wt. % |
|---|---|
| Water | 81.90 |
| EDTA | 0.10 |
| Sodium Stearate | 10.00 |
| Dipropylene Glycol | 2.00 |
| Polysorbate-20 | 4.00 |
| Fragrance | 2.00 |
| Dyes | q.s. |

After testing the samples as described in Example 1, it was determined that the average evaporation rate of the fragrance was about 0.06 to about 0.08 grams per hour.

### EXAMPLE 8

Aqueous gels were formed as described in Example 1, except that the concentration of sodium stearate was decreased from 6.0 wt. % to 3.0 wt. % and PEG-150 distearate was removed. The resulting gels had the following composition:

| Component | Wt. % |
|---|---|
| Water | 88.85 |
| EDTA | 0.10 |
| Sodium Stearate | 3.00 |
| Dipropylene Glycol | 2.00 |
| Polysorbate-20 | 2.00 |
| Benzophenone -4 | 0.05 |
| Germaben ® II | 1.00 |
| Fragrance | 3.00 |
| Dyes | q.s. |

After testing the samples as described in Example 1, it was determined that the average evaporation rate of the fragrance was about 0.30 to about 0.33 grams per hour.

### EXAMPLE 9

Aqueous gels were formed as described in Example 1, except that the concentration of sodium stearate was increased from 6.0 wt. % to 10.0 wt. %; the concentration of dipropylene glycol was increased from 2 wt. % to 68 wt. %; the concentration of the fragrance was increased from 3 wt. % to 10 wt. %; and PEG-150 distearate was removed. The resulting gels had the following composition:

| Component | Wt. % |
|---|---|
| Water | 9.85 |
| EDTA | 0.10 |
| Sodium Stearate | 10.00 |
| Dipropylene Glycol | 68.00 |
| Polysorbate-20 | 2.00 |
| Benzophenone -4 | 0.05 |
| Fragrance | 10.00 |
| Dyes | q.s. |

After testing the samples as described in Example 1, it was determined that the average evaporation rate of the fragrance was less than about 0.10 grams per hour.

The present inventors have discovered that a scented candle formed from an aqueous gel may be utilized to provide effective dissipation of a volatile fragrance to the surrounding environment. For example, the average evaporation rate of the fragrance during use may be at least about 0.1 grams per hours, in some embodiments at least about 0.2 grams per hours, and in some embodiments, at least about 0.3 grams per hours. Such a scented candle is particularly tailored for use with an aroma-producing system that employs an electrically operated warming device rather than a wick that burns the candle. Further, unlike conventional candles, the aqueous gel is able to melt relatively quickly with a warming device.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. An aroma-producing system comprising:
an aqueous gel having an aqueous phase and an oil phase, the gel comprising a volatile fragrance; and
a warming device that is capable of heating the gel so that the volatile fragrance is released from the aqueous gel into the surrounding environment.

2. The aroma-producing system of claim 1, wherein the aqueous gel is formed from an oil-in-water emulsion.

3. The aroma-producing system of claim 1, wherein the aqueous gel is a water-in-oil emulsion.

4. The aroma-producing system of claim 1, wherein the aqueous gel comprises water in an amount of at least about 25 wt. %.

5. The aroma-producing system of claim 1, wherein the aqueous gel comprises water in an amount of at least about 50 wt. %.

6. The aroma-producing system of claim 1, wherein the aqueous gel further comprises a gelling agent.

7. The aroma-producing system of claim 6, wherein the gelling agent is a derivative of a vegetable fat.

8. The aroma-producing system of claim 7, wherein the gelling agent is a metal salt of a fatty acid.

9. The aroma-producing system of claim 8, wherein the gelling agent is sodium stearate.

10. The aroma-producing system of claim 6, wherein the gelling agent constitutes from about 4 wt. % to about 10 wt. % of the aqueous gel.

11. The aroma-producing system of claim 1, wherein the aqueous gel further comprises a polyhydric alcohol.

12. The aroma-producing system of claim 1, wherein the aqueous gel further comprises a nonionic surfactant having an HLB value of from about 8 to about 30.

13. The aroma-producing system of claim 12, wherein the nonionic surfactant is a polyoxyalkylene glycol ester.

14. The aroma-producing system of claim 13, wherein the polyoxyalkylene glycol ester has one of the following general formulae:
R—C(O)O—(O—CH₂—CH₂—)ₙ—OH
or
R—C(O)O—(O—CH₂—CH₂—)ₙ—CO(O)—R′
wherein R and R′ are independently a branched or unbranched, alkyl or alkenyl radical; and
n is 4 or more.

15. The aroma-producing system of claim 12, wherein the nonionic surfactant is an ethoxylated fatty acid sorbitan ester.

16. The aroma-producing system of claim 1, wherein the volatile fragrance constitutes from about 1 wt. % to about 10 wt. % of the aqueous gel.

17. The aroma-producing system of claim 1, wherein the aqueous gel further comprises a preservative, chelating agent, UV stabilizer, colorant, pH adjuster, or combination thereof.

18. The aroma-producing system of claim 1, wherein the aqueous gel is disposed within a container.

19. The aroma-producing system of claim 18, wherein the warming device includes a base that is configured to receive the container.

20. The aroma-producing system of claim 19, wherein the warming device further includes a sidewall that extends upwardly from the base.

21. The aroma-producing system of claim 1, wherein the warming device is electrically operated.

22. The aroma-producing system of claim 1, wherein the aqueous gel is wickless.

23. The aroma-producing system of claim 1, wherein a wick is disposed within the aqueous gel.

24. A scented candle comprising a gel having an aqueous phase and an oil phase, the gel comprising a volatile fragrance and water in an amount of at least about 25 wt. %.

25. The scented candle of claim 24, wherein the gel is formed from an oil-in-water emulsion.

26. The scented candle of claim 24, wherein the gel comprises water in an amount of at least about 50 wt. %.

27. The scented candle of claim 24, wherein the gel further comprises a gelling agent.

28. The scented candle of claim 27, wherein the gelling agent is a derivative of a vegetable fat.

29. The scented candle of claim 28, wherein the gelling agent is a metal salt of a fatty acid.

30. The scented candle of claim 29, wherein the gelling agent is sodium stearate.

31. The scented candle of claim 27, wherein the gelling agent constitutes from about 4 wt. % to about 10 wt. % of the aqueous gel.

32. The scented candle of claim 24, wherein the gel further comprises a polyhydric alcohol.

33. The scented candle of claim 24, wherein the gel further comprises a nonionic surfactant having an HLB value of from about 8 to about 30.

34. The scented candle of claim 33, wherein the nonionic surfactant is a polyoxyalkylene glycol ester.

35. The scented candle of claim 34, wherein the polyoxyalkylene glycol ester has one of the following general formulas:
R—C(O)O—(O—CH₂—CH₂—)ₙ—OH
or
R—C(O)O—(O—CH₂—CH₂—)ₙ—CO(O)—R′
wherein R and R′ are independently a branched or unbranched, alkyl or alkenyl radical; and
n is 4 or more.

36. The scented candle of claim 33, wherein the nonionic surfactant is an ethoxylated fatty acid sorbitan ester.

37. The scented candle of claim 24, wherein the volatile fragrance constitutes from about 1 wt. % to about 10 wt. % of the gel.

38. The scented candle of claim 24, wherein the gel further comprises a preservative, chelating agent, UV stabilizer, colorant, pH adjuster, or combination thereof.

39. The scented candle of claim 24, wherein the candle is wickless.

40. A scented candle comprising an aqueous gel formed from an oil-in-water emulsion, the gel comprising:
water in an amount of at least about 50 wt. %;
a gelling agent comprising a metal salt of a fatty acid;
a polyhydric alcohol;
a nonionic surfactant having an HLB value of from about 8 to about 30; and
a volatile fragrance.

41. The scented candle of claim 40, wherein the gelling agent is sodium stearate.

42. The scented candle of claim 40, wherein the nonionic surfactant is a polyoxyalkylene glycol ester.

43. The scented candle of claim 40, wherein the gelling agent constitutes from about 4 wt. % to about 10 wt. % of the aqueous gel.
